(19) United States
(12) Patent Application Publication
(10) Pub. No.: US 2001/0047346 A1
(43) Pub. Date: Nov. 29, 2001

(54) Artificial intelligence and computer interface

(76) Inventors: Dejian Liu, West Covina, CA (US); Luyuan Liu, West Covina, CA (US); Ming Liu, West Covina, CA (US)

Correspondence Address: David and Raymond Patent Group, 1050 Oakdale Lane, Arcadia, CA, 91006, US

(21) Appl. No.: 09/833,235

(22) Filed: Apr. 10, 2001

Related U.S. Application Data
(60) Provisional application No. 60/195,316, filed on Apr. 10, 2000.

(51) Int. Cl. G06N 3/00

(52) U.S. Cl. 706/13

(57) ABSTRACT

The present invention identifies a new way of constructing chatter robots based on client-server communication via Internet. An innovative artificial intelligence is provided based on the recognition of relationship between different sentences in human conversation. Powered by the new kind of chatter robots, the present invention also includes a new kind of computer interface to allow users to obtain information and complete computer related tasks by communicate with the computer via common natural language. The present invention also includes ways of incorporate the new artificial intelligence and computer interface with online computer games, both to enhance the computer games and to further retain games players.

### CROSS REFERENCE TO RELATED APPLICATION

This is a regular application of a provisional application, application Ser. No. 60/195,316, filed Apr. 10, 2000.

### BACKGROUND OF THE PRESENT INVENTION

The present invention relates to a new way of constructing chatter robots based on client-server communication via Internet, wherein artificial intelligence is made possible with a server side Oracle database, a client side computer interface, a server side semi-automatic machine learning module, and human assistance.

### SUMMARY OF THE PRESENT INVENTION

A main object of the present invention is to provide an innovative artificial intelligence based on the recognition of relationship between different sentences in human conversation.

It is another object of the present invention that includes a new kind of computer interface, powered by the new kind of chatter robots, so as to allow users to obtain information and complete computer related tasks by communicate with the computer via common natural language.

It is another object of the present invention that includes ways of incorporate the new artificial intelligence and computer interface with online computer games, both to enhance the computer games and to further retain games players.

It is another object of the present invention that offers a new way of constructing chatter robots using client-server communication via Internet and ways of utilizing this new chatter robots as Internet Portal and various aids for computer users.

It is another object of the present invention that includes ways of incorporating these chatter robots both as non-player-characters in computer online games and extension of computer online games into users' computer desktop.

### DETAILED DESCRIPTION OF THE PREFERRED EMBODIMENT

Chatter robots and artificial intelligence: A simple human convention session is not an exact sentence and conversation subjects, which tend to change quickly form one to seemly unrelated others, loosely maintain the relationship between sentences. This invention constructs a new and practical artificial intelligence (AI) based on definition of sentences level relationship.

Instead of trying to teach the artificial intelligence (AI) to understand every sentence, we simply teach the artificial intelligence (AI) to recognize the uniqueness of the sentence, i.e. sentence identification (sentence ID) based on meaningful words and the order of these meaningful words, then lookup the sentence ID in a sentences relationship database and choose a reply. The sentences relationship database includes original sentences, meaningful words from the sentences, category of the sentences, and the list of possible sentences as a reply to the original sentences.

A conversion sentences relationship database is constructed in Chinese language for demonstration purposes. Starting with 8,000 commonly used Chinese words, a team of 80 people was asked to use these words in normal conversations, and sentences were recorded. Usable sentences were selected with their sentence ID generated. About 40,000 sentences were selected and a one-sentences reply to these sentences was obtained with the help of the same 80 people team. The 200,000 reply sentences were filtered based on their conversation quality and about 150,000 sentences were used. These sentences were also cataloged according to manners (mean, nice, normal, and etc) and relationship (normal, friend, lover). Then the selected sentences, the sentences ID, and the sentence category, are input into one database, together with the replying sentence ID for the 40,000 sentences.

A learning process of the artificial intelligence (AI) is done with help of human assistance. Whenever users input a sentence that has a sentences ID that is not included in the database, or with the sentences ID listed in the database, but without identifying a replying sentence, a conversation technique (agreeing, change conversational subject, and etc.) is used to keep the conversation going on, while the system logs a new un-replyable sentence. The answers to the new sentences are complied and input into the database by the human team, so the next time when the same question is asked, the artificial intelligence (AI) will be able to answer correctly. The artificial intelligence (AI) automatic learning process can be accomplished when enough users participate in the conversation with the artificial intelligence (AI). In that case the relationship between sentences can be established based on interrelationship of every sentences ID. Human interaction will help the accuracy of identify the interrelationship, but will be unnecessary when the usage of the artificial intelligence (AI) raises to a certain level where the interrelationship of two sentences ID is confirmed by multiple users' interaction with the artificial intelligence (AI).

To improve the matching of sentence ID, a modified vocabulary treasure database were used to increase numbers of sentence by several fold in artificial intelligence's sentence relationship database.

The value of chatter robots is of limited entertainment for computer users if they don't serve other purposes. As an Internet artificial intelligence (AI), this new artificial intelligence (AI) can handle common knowledge query with the construction of common knowledge database, With the common knowledge database, questions like “what is the distance between Los Angeles and New York” can be answered, by automatically inputting related questions and answers into the sentence relationship database or via direct interaction with the common knowledge database.

Moreover, with the ability of this new chatter robot, a new kind of computer Interface can thus be achieved, running on “Window” or other graphically operating systems. It is basically a character as an interface between the artificial intelligence (AI) with the users. The character can take the form of human figures, or any other figures, such as animals, frictional subjects, and etc. When executed, it is always “float” on top of other running programs.

Because its ability to chat with users and answer users' questions in common language, this onscreen character will easily fit into the role of computer assistance.

Humanlike relationship is simulated using, including but not limited to, different conversation mode, and the amount of intimacy in interaction. Different level of character-users relationship can be defined by the frequency of interactions between users and the character and other definable standard.

The figure can be scaled and can be temporary hideaway as requested by users. Because it is always accessible by users, it can directly link users quickly link users quickly and more conveniently to various Internet resources, such as search engines, web sites and web services. Incorporating with other computer software and system resource, the character can offer personalized services such as address books, data planner, bookmark management.

This new interface also includes an active recommendation system, which will suggest things for users based on their conversation contents and preference. For example, when one user inputs something including “I, want, vacation”, the artificial intelligence (AI) will automatically popup message box on the computer screen recommending the best traveling website and the hottest deals available. Another example will be to ask users “would you like a joke?” or “Want to read news?” remaining them of the things they can do on the web, and introducing to them new.

In other words, many of the commonly used computer functions are made more accessible with this new kind of interface. User loyalty is retained by accumulating user's preference and the simulating users-character relationship.

Due to the fact that online computer games as a form of online community are becoming popular worldwide. The present invention also includes a new kind of incorporation of the various online computer games with the new user interface. Since the new user interface utilized characters, game characters from various computer games can be used as the character in the new interface. Almost every online computer game now available on the market uses characters that can be separated from the main programs and be used in the new interface. That way, it would be a great way of promoting various online games, and reminding users of these games to revisit the games.

What is claimed is:

1. A method of constructing an artificial intelligence based on defining relationship between sentences, comprising the steps of:
(a) providing an artificial intelligence for sentences;
(b) forming an sentence ID for each of said sentences, which is an uniqueness of said sentence based on meaningful words and an order of said meaningful word;
(c) teaching said artificial intelligence to recognize said sentence ID; and
(d) looking up said sentence ID in a sentences relationship database and choosing a reply, wherein said sentences relationship database includes said sentences, said meaningful words from said sentences, category of said sentences, and a list of possible sentences from said sentences as said reply.

2. The method of constructing an artificial intelligence, as recited in claim 1, further comprising the steps of:
(e) providing a conversion sentences relationship database by having a predetermined number of people to use a predetermined number of words of a first language in conversations and recording sentences made during said conversations;
(f) selecting a predetermined number of usable sentences from said recorded sentences and generating said sentence ID for each of said recorded sentences;
(g) obtaining a reply sentence with respect to each of said recorded sentences;
(h) filtering said reply sentence based on a conversation quality thereof;
(i) forming a sentence category by cataloging said filtered reply sentences according to manners and relationship thereof; and
(j) inputting said selected sentences, said sentences ID, and said sentence category into one database, together with said sentence IDs of said reply sentences.

3. The method of constructing an artificial intelligence, as recited in claim 2, further comprising a learning process of said artificial intelligence, which comprises the steps of:
(i) inputting a sentence having a sentences ID not included in said database without identifying a replying sentence;
(ii) using a conversation technique to keep a conversation going on, while a system logs a new un-replyable sentence; and
(iii) complying answers to said new sentences and inputting into said database, so that when a same question is asked next time, said artificial intelligence is able to answer correctly.

4. The method of constructing an artificial intelligence, as recited in claim 3, wherein a relationship between said sentences is established based on interrelationship of each of said sentence ID.

5. The method of constructing an artificial intelligence, as recited in claim 3, wherein a modified vocabulary treasure database is used to increase numbers of sentence by several fold in said sentence relationship database so as to improve a matching of said sentence IDs.

6. The method of constructing an artificial intelligence, as recited in claim 4, wherein a modified vocabulary treasure database is used to increase numbers of sentence by several fold in said sentence relationship database so as to improve a matching of said sentence IDs.

7. The method constructing an artificial intelligence, as recited in claim 1, wherein a computer interface is used to enhance a ability of a chatter robot, which is basically a character as an interface between said artificial intelligence with users, wherein said character takes a form of figures and is programmed to “float” on top of other running software programs of a computer, so as to interact with said users via common natural language, adapted for having conversation with said users, completing computer function for said users and developing a humanlike relationship with said users.

8. The method constructing an artificial intelligence, as recited in claim 7, wherein said computer interface further comprises an active recommendation system, which suggests things for said users based on conversation contents and preference thereof.

9. The method constructing an artificial intelligence, as recited in claim 7, wherein said computer interface is used to promote computer subjects by utilizing characters from said computer subjects.

10. The method constructing an artificial intelligence, as recited in claim 2, wherein a computer interface is used to enhance a ability of a chatter robot, which is basically a character as an interface between said artificial intelligence with users, wherein said character takes a form of figures and is programmed to “float” on top of other running software programs of a computer, so as to interact with said users via common natural language, adapted for having conversation with said users, completing computer function for said users and developing a humanlike relationship with said users.

11. The method constructing an artificial intelligence, as recited in claim 10, wherein said computer interface further comprises an active recommendation system, which suggests things for said users based on conversation contents and preference thereof.

12. The method constructing an artificial intelligence, as recited in claim 10, wherein said computer interface is used to promote computer subjects by utilizing characters from said computer subjects.

13. The method constructing an artificial intelligence, as recited in claim 3, wherein a computer interface is used to enhance a ability of a chatter robot, which is basically a character as an interface between said artificial intelligence with users, wherein said character takes a form of figures and is programmed to “float” on top of other running software programs of a computer, so as to interact with said users via common natural language, adapted for having conversation with said users, completing computer function for said users and developing a humanlike relationship with said users.

14. The method constructing an artificial intelligence, as recited in claim 13, wherein said computer interface further comprises an active recommendation system, which suggests things for said users based on conversation contents and preference thereof.

15. The method constructing an artificial intelligence, as recited in claim 13, wherein said computer interface is used to promote computer subjects by utilizing characters from said computer subjects.

16. The method constructing an artificial intelligence, as recited in claim 5, wherein a computer interface is used to enhance a ability of a chatter robot, which is basically a character as an interface between said artificial intelligence with users, wherein said character takes a form of figures and is programmed to “float” on top of other running software programs of a computer, so as to interact with said users via common natural language, adapted for having conversation with said users, completing computer function for said users and developing a humanlike relationship with said users.

17. The method constructing an artificial intelligence, as recited in claim 16, wherein said computer interface further comprises an active recommendation system, which suggests things for said users based on conversation contents and preference thereof.

18. The method constructing an artificial intelligence, as recited in claim 16, wherein said computer interface is used to promote computer subjects by utilizing characters from said computer subjects.

19. The method constructing an artificial intelligence, as recited in claim 6, wherein a computer interface is used to enhance a ability of a chatter robot, which is basically a character as an interface between said artificial intelligence with users, wherein said character takes a form of figures and is programmed to “float” on top of other running software programs of a computer, so as to interact with said users via common natural language, adapted for having conversation with said users, completing computer function for said users and developing a humanlike relationship with said users, wherein said computer interface further comprises an active recommendation system, which suggests things for said users based on conversation contents and preference thereof.

20. The method constructing an artificial intelligence, as recited in claim 6, wherein a computer interface is used to enhance a ability of a chatter robot, which is basically a character as an interface between said artificial intelligence with users, wherein said character takes a form of figures and is programmed to “float” on top of other running software programs of a computer, so as to interact with said users via common natural language, adapted for having conversation with said users, completing computer function for said users and developing a humanlike relationship with said users, wherein said computer interface is used to promote computer subjects by utilizing characters from said computer subjects.
